(19) United States
(12) Patent Application Publication
(10) Pub. No.: US 2002/0167950 A1
(43) Pub. Date: Nov. 14, 2002

(54) Fast data path protocol for network switching

(75) Inventors: Rong-Feng Chang, Irvine, CA (US); John Lam, Foothill Ranch, CA (US); Po-Shen Lai, San Jose, CA (US); Brian Yang, Monterey Park, CA (US)

Correspondence Address: ARTER & HADDEN, LLP, 1100 HUNTINGTON BUILDING, 925 EUCLID AVENUE, CLEVELAND, OH, 44115-1475, US

(73) Assignee: Zarlink Semiconductor V.N. Inc., Irvine, CA (US)

(21) Appl. No.: 10/047,057

(22) Filed: Jan. 14, 2002

Related U.S. Application Data
(60) Provisional application No. 60/261,269, filed on Jan. 12, 2001.

(51) Int. Cl. H04L 12/28

(52) U.S. Cl. 370/396; 370/389

(57) ABSTRACT

A protocol and header format of a network architecture for communication between a plurality of network devices. In particular, the data frame is resolved at the source device to ascertain the data frame type, and the data frame is forwarded with a virtual network identifier and priority information from the source device to a destination device of the network. The forwarded data frame also includes control information.

This application claims priority under 35 U.S.C. §119(e) to U.S. Provisional Patent application Serial No. 06/261,269 filed Jan. 12, 2001 and entitled “Fast Data Path Protocol For Network Switching.”

### BACKGROUND OF THE INVENTION

This invention is related to network switching, and more particularly, a protocol architecture for moving frames of data throughout the network.

The advent of the Internet made available a whole host of opportunities for consumers, as well as businesses. Consequently, as more and more of consumers and businesses get “connected” to online resources in order to avail themselves of these opportunities, the available bandwidth begins to suffer. Bandwidth suffers for a number of reasons. As more people log on, more and more data packets are generated for communication between the nodes. The increase in network traffic also causes an increase in data collisions which, in many cases, force a retransmission of the corrupted data, which in turn consumes more bandwidth and delays in the data arriving at the node to which it was addressed. In more severe cases, collisions result in lost data which can have a dramatic impact on online businesses which function to handle money and personal account information.

What is needed is a protocol architecture which more efficiently and effectively controls the flow of information over a network.

### SUMMARY OF THE INVENTION

The present invention disclosed and claimed herein, in one aspect thereof, comprises a fast data path protocol for communication between a plurality of network devices. In particular, a method of communicating a data frame of a source device of a network wherein the data frame is resolved at the source device to ascertain the data frame type, and the data frame is forwarded with a virtual network identifier and priority information from the source device to a destination device of the network. The data frame also includes control information.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a general block diagram of a daisy-chain configuration of distributed switches, in accordance with a disclosed embodiment;

FIG. 2 illustrates a general block diagram of a matrix configuration of distributed switches and a switching fabric, in accordance with a disclosed embodiment;

FIG. 3 illustrates a flow chart for processing unicast traffic, in accordance with a disclosed embodiment;

FIG. 4 illustrates a flow chart for processing multicast traffic when utilizing the VLAN ID, in accordance with a disclosed embodiment;

FIG. 5 illustrates a flow chart for processing multicast traffic when utilizing a bitmap approach, in accordance with a disclosed embodiment;

FIG. 6 illustrates a flow chart of the unicast handshaking process for transmitting a unicast frame, in accordance with a disclosed embodiment;

FIG. 7 illustrates a system block diagram for the data path interface between distributed switches in a head-to-head configuration when operating in a daisy-chain mode;

FIG. 8 illustrates a more detailed daisy-chain configuration of FIG. 1 utilizing three or more distributed switches connected in a loop;

FIG. 9 illustrates a head-to-head system block diagram for the data path interface between a distributed switch and a switching fabric when operating in a matrix mode;

FIG. 10 illustrates a timing diagram of the data path Message Control signals, in accordance with a disclosed embodiment;

FIG. 11 illustrates a sample Ethernet frame which is partitioned into smaller messages, in accordance with a disclosed embodiment;

FIGS. 12a-12h illustrate various header formats of the disclosed data path protocol;

FIG. 13 illustrates a transmit/receive FIFO structure utilized for the daisy-chain mode of operation, according to a disclosed embodiment; and

FIG. 14 illustrates a transmit/receive FIFO structure utilized for the matrix mode of operation, according to a disclosed embodiment.

### DETAILED DESCRIPTION OF THE INVENTION

The disclosed communication protocol architecture serves as a fast data path between two or more distributed switches (DS), and between one or more distributed switches and a switching fabric (SF). The protocol is applicable to a IEEE 802.1Q VLAN Tag frame format used extensively in virtual LAN (VLAN) environments. The protocol employs a 32-bit-wide, point-to-point, high speed, full-duplex interface data pipe between devices. The protocol is operable under at least two connection modes designated as matrix mode, and chaining (or daisy-chain) mode. In the chaining mode, a DS device interrogates all messages passing on the data path, and compares its device ID with the destination device ID embedded in the incoming message. If the two ID's are the same, the DS device accepts the message. If the two ID's are not the same, the DS device sends the message to its outgoing port in order to forward the message to the next DS device in the string of switches. In matrix mode, the destination DS device receives only messages destined for it (i.e., in which the destination device ID matches its device ID).

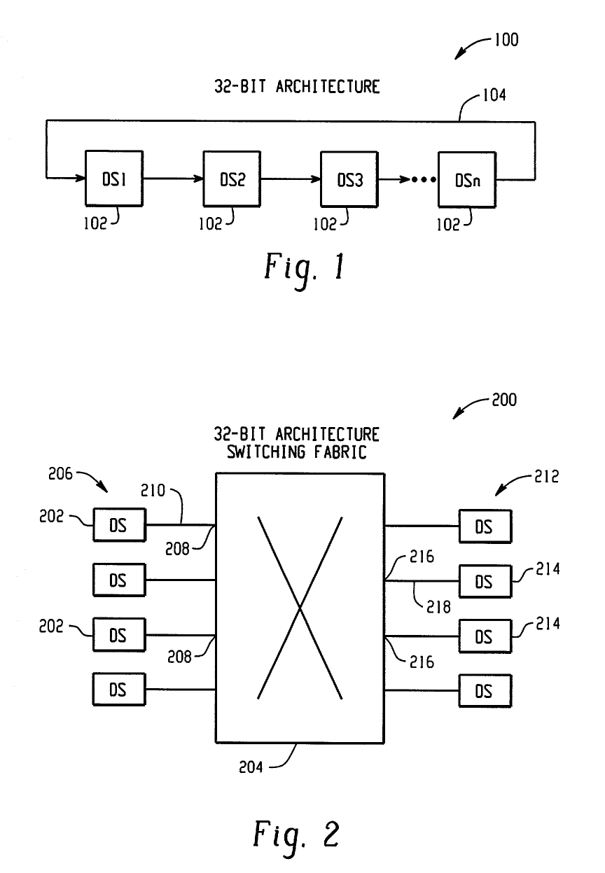

Referring now to FIG. 1, there is illustrated a general block diagram of a daisy-chain configuration 100 of distributed switches (DS1, DS2, DS3, . . . , DSn) 102, in accordance with a disclosed embodiment. In daisy-chain mode, each DS 102 is connected to another DS 102 with the 32-bit data bus 104. For example, as illustrated, the output of switch DS1 connects to the input of switch DS2, the output of switch DS2 connects to the input of switch DS3, etc. The output of switch DSn then loops back to the input of switch DS1. Any DS-to-DS application is relegated to daisy-chain mode. The daisy-chain configuration is operable with a 32-bit architecture, however, the disclosed protocol is not limited to this type of architecture, but can be scaled in accordance with larger (or smaller) architectures such as 64-bit applications. The daisy chain communication interface is different then that used when in matrix mode configuration, and each will be discussed in greater detail hereinbelow. The disclosed protocol architecture is not limited in the number of distributed switches 102 which can be chained (or looped) together.

Referring now to FIG. 2, there is illustrated a general block diagram of a matrix configuration 200 of distributed switches DS and a switching fabric 204, in accordance with a disclosed embodiment. In matrix mode, a source DS 202 on the source side 206 connects to one of the input ports 208 of switching fabric 204 with a 32-bit data bus 210. On the destination side 212, each destination device DS 214 connects to an output port 216 (also called an “outgoing” port) of the SF 204 via a 32-bit data bus 218 (similar to the 32-bit bus 104), which data buses 210 and 218 are both operable to accommodate the disclosed data path protocol. Thus, any data frame entering the SF 204 from a source DS 202 can be switched, via an internal SF device (not shown), to any of the output ports 216 and respective destination DS 214. A look-up table exists in the SF 204 that maps a destination device ID to an outgoing port of the SF 204, which outgoing port connects to the destination device. Any application where a DS-to-SF connection is realized, is relegated to matrix mode.

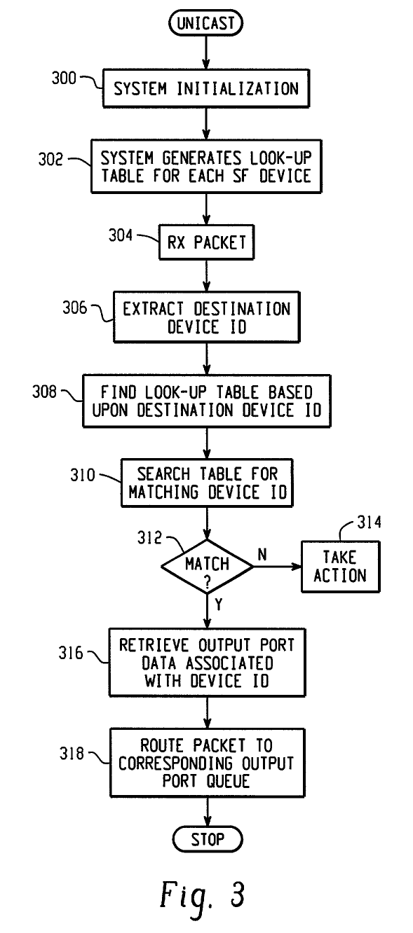

Referring now to FIG. 3, there is illustrated a flow chart for processing unicast traffic in matrix mode, in accordance with a disclosed embodiment. In a network system, each device is assigned a unique device ID. At the system initialization phase, as indicated in a function block 300, the system sets up a look-up table for each SF device, as indicated in a function block 302. In this look-up table, each entry contains a mapping of a destination device ID to the outgoing port 216 of the SF 204. Note that this look-up table is used only for unicast traffic (while the routing of multicast traffic is based upon a Virtual LAN (VLAN) ID or bit map). Flow is then to a function block 304 where the SF 204 receives a data message (or packet). The destination device ID is then extracted from the message, as indicated in a function block 306. The switching device then looks up the corresponding look-up table based upon the destination device ID contained within the data message, as indicated in a function block 308, and performs a table search for a matching destination device ID, as indicated in a function block 310. Flow is then to a decision block 312 to determine of a match has occurred. If not, flow is out the “N” path to a function block 314 to take some sort of action in response to the destination device ID not being in the table. For example, this action could include re-extracting the destination device ID under the presumption that it was originally obtained in error. Other actions could be programmed at the discretion of the technician. If a match has occurred, flow is out the “Y” path of decision block 312 to a function block 316 to retrieve the corresponding output port 216 information. The data message is then forwarded to the output port queue that corresponds to the destination DS 214 having that destination device ID, as indicated in a function block 318.

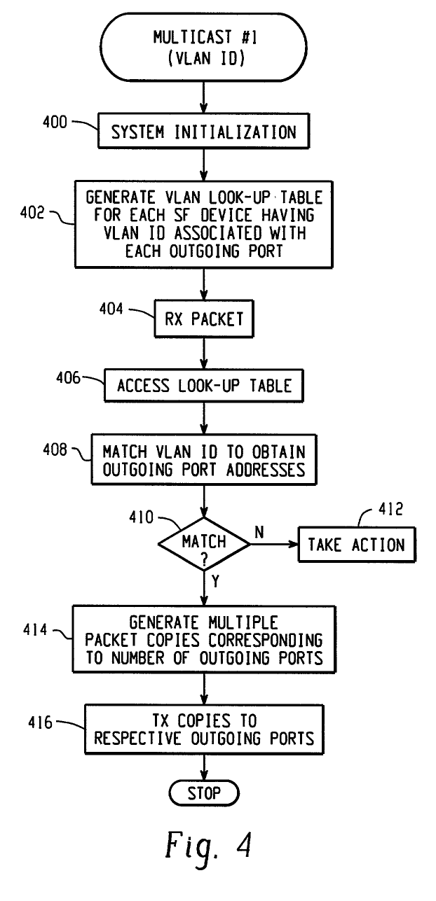

As mentioned hereinabove, two methods are provided for the distribution of multicast messages to multiple devices. Referring now to FIG. 4, there is illustrated a flow chart for processing multicast traffic when utilizing the VLAN ID, in accordance with a disclosed embodiment. At the system initialization phase, as indicated in a function block 400, the system sets up a VLAN look-up table for each SF device, as indicated in a function block 402, using the VLAN ID as an index for each entry of the look-up table. Each table entry contains a mapping of the VLAN ID to any outgoing ports 216 of the SF 204. Flow is then to a function block 404 where a message is received into the SF 204. The switching device of the SF 204 then accesses the appropriate look-up table in accordance with the VLAN ID, as indicated in a function block 406. Flow continues to a function block 408 where the VLAN ID is used in a matching process in order to obtain the corresponding output port queue information. Flow is then to a decision block 410 to determine if a match has occurred. If not, flow is out the “N” path to a function block 412 to take some kind of action in response to the VLAN ID not being found in the look-up table. For example, this action could be to repeat the process for obtaining the VLAN ID, and then performing another matching process on the look-up table. Other actions can also be implemented at the discretion of the technician implementing the disclosed protocol architecture.

On the other hand, if a successful match does occur, flow is out the “Y” path of decision block 410 to function block 414 where the SF 204 generates multiple copies of the multicast message for forwarding to one or more outgoing ports 216 associated with that look-up table entry. Flow is then to a function block 416 where the multiple copies of the message are then transmitted to the respective outgoing ports 216 of the SF 204.

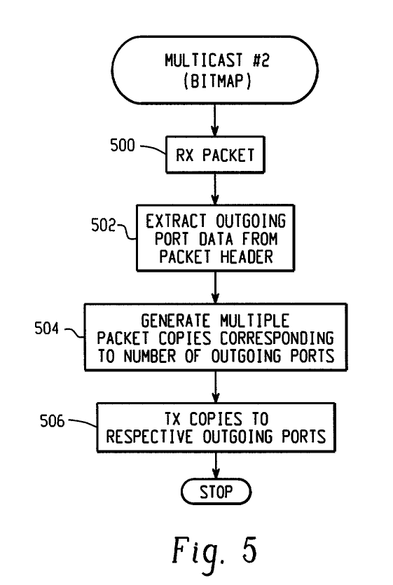

Referring now to FIG. 5, there is illustrated a flow chart for processing multicast traffic when utilizing a bitmap approach, in accordance with a disclosed embodiment. The second method for handling multicast messages utilizes a bit-mapping approach, which is useful for a system implementation having multiples of 16-ports. Without requiring the look-up of the internal mapping table in the SF 204, the outgoing ports 216 associated with a particular multicast message are explicitly encoded in the message header. In operation, when the SF 204 receives a multicast message packet, as indicated in a function block 500, the output port information encoded in the message header is extracted therefrom, as indicated in a function block 502. Flow continues to a function block 504 where multiple message copies of the multicast message are then generated in accordance with the number of ports indicated in the bitmap information. The multiple copies are then transmitted to the corresponding output ports 216, as indicated in a function block 506.

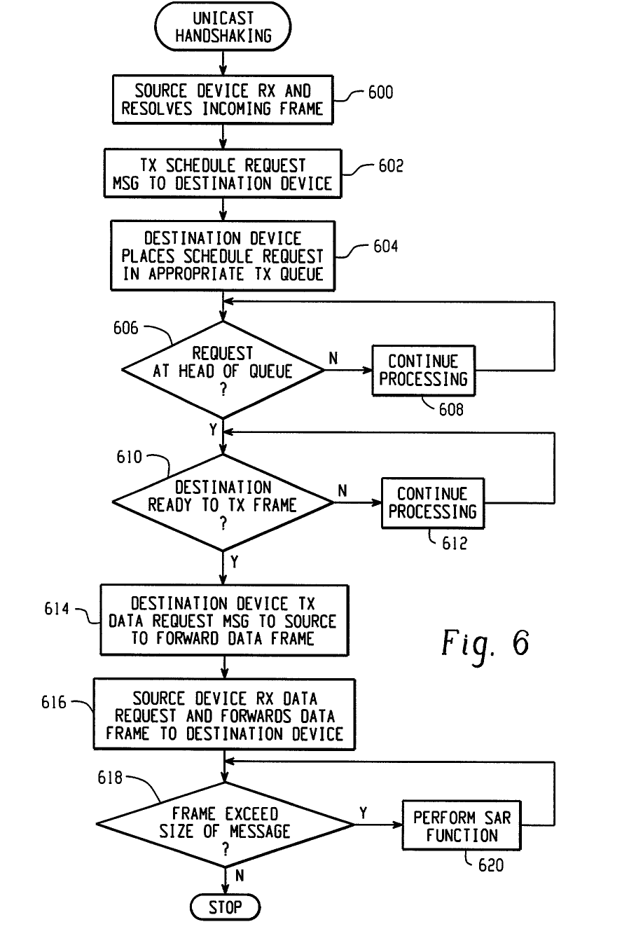

Referring now to FIG. 6, there is illustrated a flow chart of the unicast handshaking process for transmitting a unicast frame, in accordance with a disclosed embodiment. A three-way handshaking protocol is used to transfer a unicast frame across the interface, in accordance with the disclosed architecture. When the source DS 202 receives and resolves an incoming message frame, as indicated in a function block 600, it first sends a schedule request (SCH REQ) control message to the destination device DS 214, as indicated in a function block 602. Flow continues to a function block 604 where the destination DS 214 places the schedule request message in its corresponding transmit queue. Flow is then to a decision block 606 to determine if the schedule request message is at the head-of-line position of the queue. If not, flow is out the “N” path to a function block 608 to continue processing the queue messages. The output of function block 608 then loops back to the input of the decision block 606 to determine if the schedule request has arrived at the head-of-line position of the queue. If so, flow is out the “Y” path to a decision block 610 to determine if, in addition to the schedule request message being at the head of the queue, the destination DS 214 is ready to transmit the frame message out. If not, flow is out the “N” path to a function block 612 where the destination DS 214 continues processing until it is ready to transmit the frame message. The output of function block 612 then loops back to the input of decision block 610 to determine if the destination DS 214 is ready to transmit the frame. When the schedule request message is at the head-of-line position of that queue (i.e., ready to be processed), and the destination device 214 is ready to transmit the frame, flow is out the “Y” path of decision block 610 to a function block 614, where the destination DS 214 transmits back to the source DS 202 a data request message (DATA REQ) requesting that the source DS 202 forward the data frame.

Flow is next to a function block 616 where the source DS 202 receives the data request from the destination DS 214 and, in response thereto, forwards the one or more data frames to the destination DS 214. Note that if the size of a data frame (also called the “payload”) exceeds the maximum size of message permitted (e.g., 128 bytes), a segmentation and reassembly (SAR) function will be performed. The SAR function processes relatively large data packets into smaller packets for purposes of achieving compatibility with the disclosed protocol. Therefore, flow is to a decision block 618 to determine it the payload portion exceeds the maximum stipulated size of 128 bytes. If so, flow is out the “Y” path to a function block 620 to perform the SAR function. The output of function block 620 loops back to the input of decision block 618 to again determine if the data frame just SAR'd is still too large, and continues to loop until the data frame is the proper size for transmission. If not, flow is out the “N” path to continue forwarding the data frames to the destination DS 214 until no more frames are available for forwarding. Flow is then to a Stop point.

Note that multicast messaging does not require the aforementioned handshaking procedure, since a multicast data frame is forwarded only after the location of the destination DS 214 is resolved.

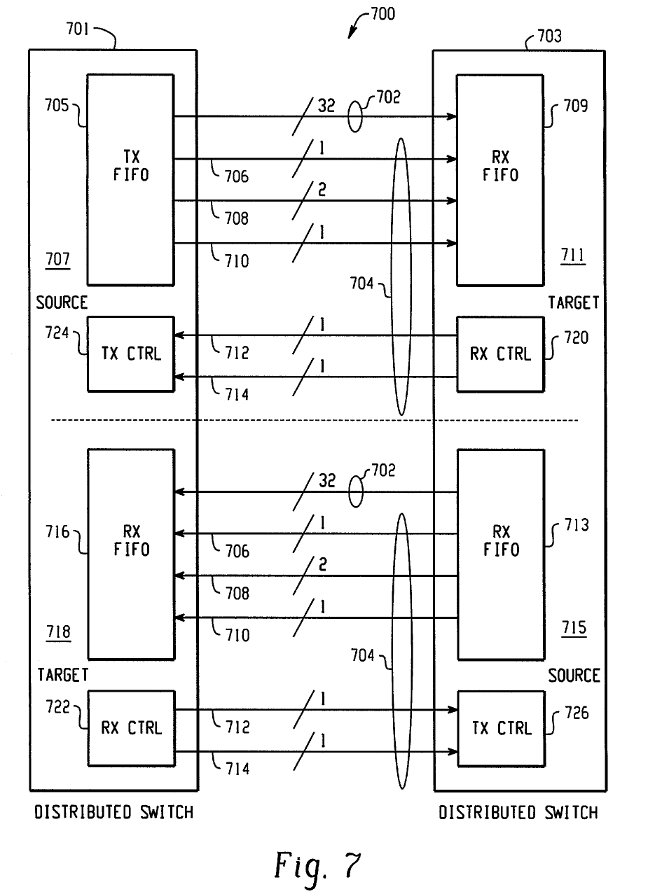

Referring now to FIG. 7, there is illustrated a system block diagram for the data path interface 700 between two daisy-chained DS devices 701 and 703 (each similar to DS device 102) in a head-to-head configuration. The head-to-head configuration uses only two devices which are connected to each other. FIG. 7 includes a dotted line for convenience to show the separation of both the receive and transmit portions of each of the DS devices (701 and 703), and the connections therebetween. The disclosed interface 700 (similar to interface bus 104) employs thirty-two data signals (designated XP_D[31:0]) imposed upon respective data lines 702 and six control signals imposed upon six control signal lines 704, for each direction, when in the daisy-chain mode. The thirty-two data lines 702 form a transmission “pipe” that carries the data portion of the message from a transmit FIFO (TX FIFO) 705 of a source portion 707 of DS 701 to a receive FIFO (RX FIFO) 709 of a target (or destination) portion 711 of DS 703. Additionally, a transmission pipe of thirty-two data signals is formed of respective data lines from a RX FIFO 713 of a source portion 715 of DS 703 to a RX FIFO 716 of a target portion 718 of DS 701.

The direction of all data signals is from the source portion (707 and 715) to the respective target portion (711 and 718). Control signals include flow control signals are carried on flow control signal lines 712 and 714, which flow control signals are sent in a direction opposite of the data signals on the data lines 702. A receive control (RX Ctrl) logic 720 of the target portion 711 transmits flow control information to a transmit control (TX Ctrl) logic 724 of the source portion 707. Similarly, a RX Ctrl logic 722 of the target portion 718 transmits flow control information to a TX Ctrl logic 726 of the source portion 715. In the daisy-chain embodiment, the flow control signals that are transmitted from the target portions (711 and 718) to the respective source portions (707 and 715) include a multicast flow control signal XOFF_FCM on the flow control line 712 and a unicast flow control signal XOFF_FCU on the flow control line 714, which indicate either multicast or unicast frames, respectively.

Other control signals include clock, message and parity signals that flow from the TX FIFOs (705 and 713) to the respective target portion RX FIFOs (709 and 716) with the direction of data flow on respective signal lines 706, 708 and 710. That is, the Transmit Clock signal (XP_CLK) is transmitted on the clock line 706, Message Control signals (XP_C[1:0]) transmitted on a pair of message control lines 708, and the Parity signal (XP_P) transmitted on the on a parity line 710.

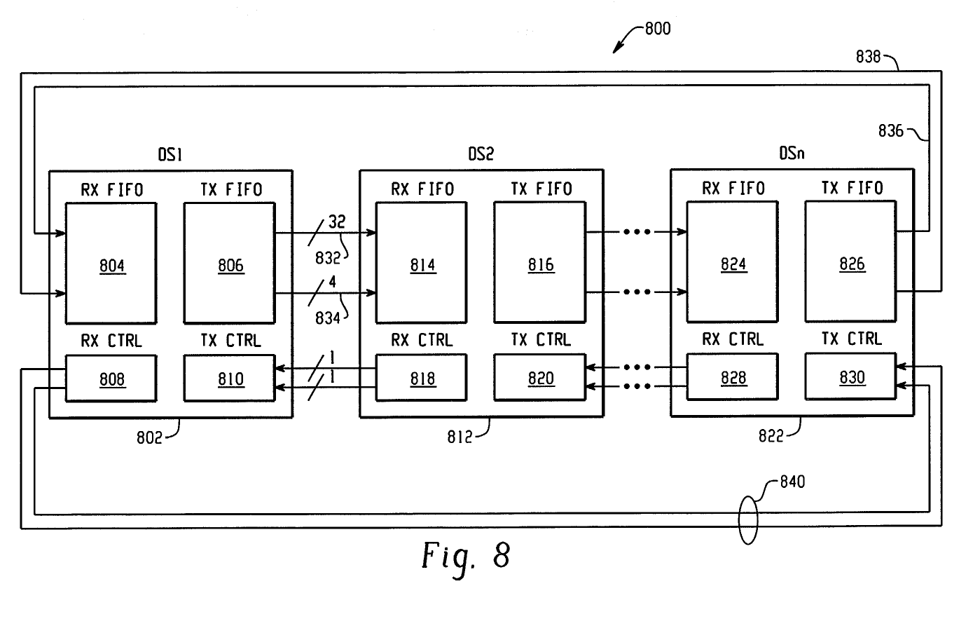

Referring now to FIG. 8, there is illustrated a more detailed daisy-chain configuration 800 of FIG. 1 utilizing three or more distributed switches DS1, DS2, . . . , DSn (all similar to DS 102) connected in a loop. A first switch DS 802 comprises a RX FIFO 804, a TX FIFO 806, a RX Ctrl logic 808, and a TX Ctrl logic 810. A second (and downstream) switch DS 812 comprises a RX FIFO 814, a TX FIFO 816, a RX Ctrl logic 818, and a TX Ctrl logic 820. The last switch DSn in the chain, device DS 822, also comprises a RX FIFO 824, a TX FIFO 826, a RX Ctrl logic 828, and a TX Ctrl logic 830. As illustrated, data flow and signal flow for some control signals, occurs in a left-to-right direction, while other control signals are transmitted in the opposite direction. Data is transmitted from the TX FIFO 806 of DS 802 to the RX FIFO 814 of DS 812 across a 32-bit data bus 832. Parity, clock, and message control signals flow from the TX FIFO 806 to the RX FIFO 814 across control lines 834. As mentioned hereinabove, in daisy-chain mode, two additional flow control signals are used, and transmitted from the RX Ctrl logic of the subsequent device to the TX Ctrl logic pervious device (e.g., RX Ctrl 818 of DS 812 to the TX Ctrl 810 of DS 802). These flow control signals provide out-of-band unicast and multicast command messages. All intermediate (or downstream) switches connect to each other in the same manner.

The last switch in the chain (DS 822) connects to loop back to switch DS 802. Data signals from TX FIFO 826 are transmitted across data lines 836 to the RX FIFO 804 of DS 802. Similarly, the same control signals associated with control lines 834 are passed to the RX FIFO 804 from the TX FIFO 826 across control lines 838. Unicast and multicast flow control command message signals are transmitted in the opposite direction around the loop from the RX Ctrl logic 808 of DS 802 to the TX Ctrl logic 830 of DS 822 on flow control lines 840.

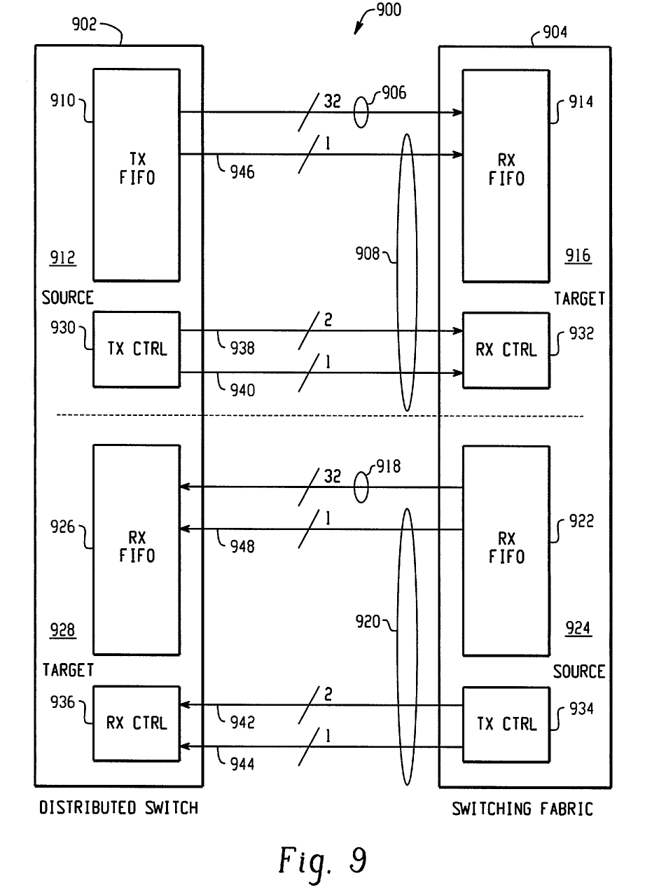

Referring now to FIG. 9, there is illustrated a head-to-head system block diagram for the data path interface 900 between a distributed switch 902 (similar to DS 202) and a switching fabric 904 (similar to SF 204) when operating in a matrix mode. FIG. 9 includes a dotted line to more clearly show the separation of both the receive and transmit portions of each of the DS device 902 and the SF 904 for this discussion, and the connections therebetween. The disclosed interface 900 employs thirty-two data signals (designated XP_D[31:0]) imposed upon respective data lines 906 and four control signals imposed upon four control signal lines 908. The thirty-two data lines 906 form a transmission pipe that carries the data portion of the message from a TX FIFO 910 of a source portion 912 of DS 902 to a RX FIFO 914 of a target (or destination) portion 916 of SF 904. Similarly, since data can flow in both directions in matrix mode, the disclosed interface 900 employs thirty-two data signals (designated XP_D[31:0]) imposed upon respective data lines 918 and four control signals imposed upon four control signal lines 920. The thirty-two data lines 918 form a transmission pipe that carries the data portion of the message from a TX FIFO 922 of a source portion 924 of SF 904 to a RX FIFO 926 of a target (or destination) portion 928 of DS 902.

In matrix mode, the direction of both data and control signals is from the source portion to the respective target portion. A TX Ctrl logic 930 of the source portion 912 of DS 902 transmits control signals to a RX Ctrl logic 932 of the target portion 916 of SF 904. Similarly, a TX Ctrl logic 934 of the source portion 924 of SF 904 transmits control signals to a RX Ctrl logic 936 of the target portion 928 of DS 902. Signals transmitted between the TX Ctrl 930 to the RX Ctrl logic 932 include Message Control signals (XP_C[1:0]) on a pair of message control lines 938, and a Parity signal (XP_P) on a parity line 940. Similarly, signals transmitted between the TX Ctrl 934 to the RX Ctrl logic 936 include Message Control signals (XP_C[1:0]) on a pair of message control lines 942, and a Parity signal (XP_P) on a parity line 944. A timing signal is imposed upon a clock line 946 connecting the TX FIFO 910 and RX FIFO 914, and a clock line 948 connecting TX FIFO 922 and RX FIFO 926. Note that in the matrix embodiment, the control signals on control lines 938, 940, 942, and 944 flow in the same direction as data flows on data lines 906, whereas in the daisy-chain embodiment, the control signals on control lines 712 and 714 flow in the direction opposite to the data on data lines 702. When a device receives a parity error, it ignores the associated message and determines when the next message starts. If the parity error is in an idle/flow control message, another idle/flow control message is forced as soon as possible to request a flow control update.

The control signals utilized in the disclosed data path interface for both the matrix mode and the daisy-chain mode are summarized in the following Table 1.

TABLE 1
Data path Control Signals.

| Signal Name | | |
|---|---|---|
| Source End | Target End | Description |
| XP_DO[31:0] | XP_DI[31:0] | 32-bit-wide Transmit Data bus - carries |
| | | the data messages, which are described |
| | | in greater detail hereinbelow. |
| XP_CLKO | XP_CLKI | Transmit Clock - a synchronous data |
| | | clock provided by the source device. |
| XP_CO[1:0] | XP_CI[1:0] | Message Control - identifies the |
| | | message boundary and type (which are |
| | | defined below). |
| XP_PO | XP_PI | Parity bit for the 34 bits of data |
| | | (XP_D[31:0]) and Message Control |
| | | (XP_C[1:0]) |
| XOFF_FCUI | XOFF_FCUO | Out-of-band XOFF for unicast (UC) |
| | | command messages (chaining mode |
| | | only). |
| XOFF_FCMI | XOFF_FCMO | Out-of-band XOFF for multicast |
| | | (MC) messages (chaining mode only). |

Message Control signals (XP_C [1:0]) which contain message boundary information, are summarized in the following Table 2.

TABLE 2
Message Control Signal Summary.

| XP_C[1:0] | Description |
|---|---|
| 10 | Start of Message (SOM) |
| 01 | End of Message (EOM) |
| 00 | Middle of Message (MOM) |
| 11 | Idle/flow control (IDLE) |

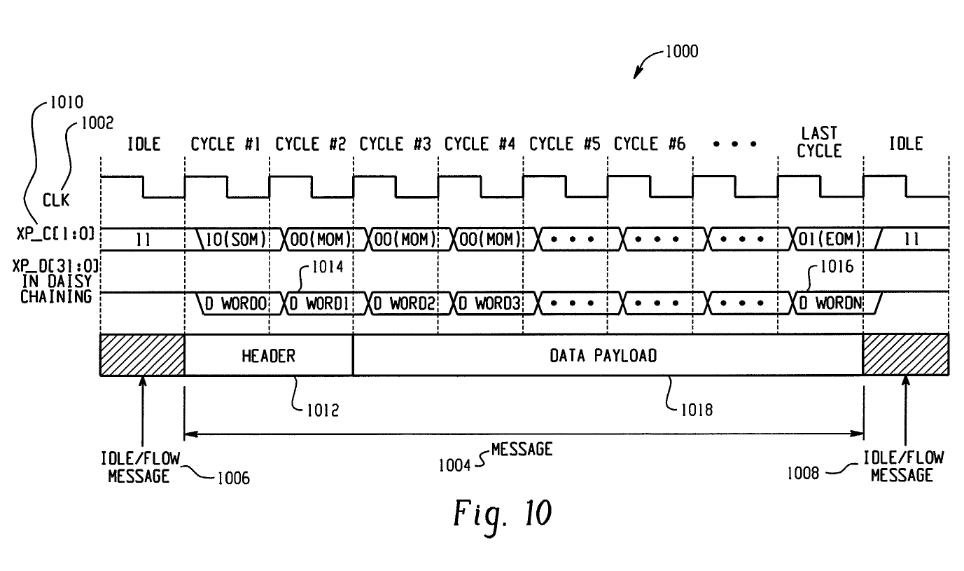

Referring now to FIG. 10, there is illustrated a timing diagram 1000 of the data path message control signals, in accordance with a disclosed embodiment. A clock signal (CLK) 1002 provides timing for transmitting a message 1004. The message 1004 is shown between two IDLE/FLOW messages (1006 and 1008) which define the beginning and the end of the message 1004. A message boundary signal XP_C[1:0] 1010 is utilized to identify the various boundaries associated with the message 1004. For example, when the message 1004 is not being transmitted, there is an idle time that is denoted by a binary value (11) in the message boundary signal 1010, as shown in Table 2. As illustrated, the message 1004 includes a header 1012 and a data payload 1018. When the header 1012 of the message 1004 is processed for transmission, the message boundary signal 1010 changes to a binary (10) during a clock CYCLE #1 to indicate the start-of-message (SOM). The message boundary signal 1010 then changes to a binary (00) during a clock CYCLE #2 to indicate that select data words 1014 are being associated with the middle-of-message (MOM). The last data word 1016 of the data payload 1018 is associated with the message boundary signal 1010 having a binary value of (01) during the LAST CYCLE of the clock signal to indicate that an end-of-message (EOM) has been detected. After the EOM has been detected, the message boundary signal 1010 changes to back to a binary (11) in accordance with the Idle/Flow message 1008 to indicate that an idle state has again occurred.

Referring now to FIG. 11, there is illustrated a sample Ethernet frame 1100 that is partitioned into smaller messages for accommodation by the disclosed architecture. Segmentation of the Ethernet frame 1100 is performed utilizing a segmentation-and-reassembly operation (SAR). A first message 1104 of the Ethernet frame 1100 consists of two parts: a header (HDR) 1106 and a payload 1102 (the payload 1102 including a first segment of the frame 1100). The first message header 1106 provides information related to the payload size, type of message, routing, and other control information for the first message 1104 when received at the destination device. The payload size indicates the size of payload in the first message 1104. The routing information includes the destination Device ID and destination Port ID. As mentioned hereinabove, each device has a look-up table configured at the initialization phase which maps each Device ID to an outgoing port.

The size of the header 1106 varies from two to four 4-byte words, and is dependent on the message 1104 type. The size of the message payload 1102 can be up to 128 bytes. Thus, an Ethernet frame 1100 that is larger than 128 bytes is required to be partitioned (or segmented) into multiple messages for transmission across the interfaces (e.g., interfaces 700 and 900). The plurality of messages 1104 received at the destination device are then reassembled to arrive at the original Ethernet frame 1100 that was transmitted utilizing SAR.

In this particular example, the frame 1100 arrived at a switch (e.g., DS 202) with a size of 356 bytes, which is too large. The SAR operation is then performed to segment the frame 1100 into smaller 128-byte messages. The SAR operation extracts the first 128-byte segment of the frame 1100 as a payload 1102 for the first message 1104. The first header 1106 is assembled along with the first payload 1102. The SAR operation then extracts a second 128-byte segment from the frame 1100 and generates a second payload 1108 with a corresponding second header 1110 to form a second message 1112. The remaining 100-byte segment of the frame 1100 are then assembled into a third payload 1114 with a corresponding third header 1116 to form a third message 1118. The frame 1100 is then transmitted to a destination device (e.g. DS 214) in the form of multiple messages (1104, 1112, and 1118) and reassembled for further processing.

Following is Table 3 which summarizes the format of the message header description.

TABLE 3
Header Description.

| FIELD | WIDTH | DESCRIPTION |
|---|---|---|
| Frame Size | 6 bits | Shown in the schedule request message to |
| | | indicate the total frame size for the sched- |
| | | uling frame in 32 bytes/unit. (6-2K bits |
| | | can be indicated) |
| PAYLOAD SIZE | 6 bits | Number of double words (4 bytes) which |
| | | are in the data field; indicates the payload |
| | | size (up to 128 bytes) of the message. |
| TYPE | 3 bits | Message type; 6 of 8 possible combina- |
| | | tions are used. |
| SUB TYPE | 6 bits | Indicates the subtype of unicast frame data |
| | | request messages; shares the same field as |
| | | frame size/payload; shown in a unicast |
| | | frame data request message only. |
| DEST DEV ID | 4 bits | Message destination device ID number. |
| DEST PORT ID | 4 bits | Port number of the destination device. |
| SOURCE DEV ID | 4 bits | Message source Device ID number. |
| SOURCE PORT ID | 4 bits | Port number of the source device. |
| VLAN ID | 12 bits | VLAN ID |
| VLAN PRIORITY | 3 bits | Priority of the VLAN; used for generating |
| | | VLAN ID for multicast tagging. |
| FRAME ID | 12 bits | Frame ID is passed as a token to the |
| (e.g., RX BUFFER | | transmitting device; one embodiment |
| HANDLE) | | uses the receive buffer handle of the |
| | | receiving buffer as the frame ID. |
| XP | 2 bits | Four levels of transmit priority for QoS. |
| TI | 1 bit | VLAN Tag In bit. |
| TO | 1 bit | VLAN Tag Out bit. |
| L3 | 1 bit | Indicates an L3 frame. |
| R | 1 bit | Indicates the “from” Gigabit port. |
| EOF | 1 bit | End-Of-Frame indicates that the current |
| | | message contains a trailer, and this |
| | | message is the last data fragment of the |
| | | frame. |
| RC | 1 bit | Indicates the transmit port to recalculate |
| | | and replace the CRC for transmission. |
| SA | 1 bit | Substitute Address - transmit port to |
| | | substitute the source MAC address for |
| | | the port MAC address. |
| FRAME LENGTH | 11 bits | Length of the frame. |
| HP | 1 bit | High Drop Priority, used in Multicast |
| | | frame; indicates the message can be |
| | | dropped in the SF when congestion |
| | | occurs. |
| Frame Sequence | 2 bits | Messages (fragments) of the same frame |
| Number | | carry identical frame sequence #. The |
| | | DS discovers the frame boundary by the |
| | | difference in frame sequence number |
| | | when the EOF fragment of a frame is |
| | | dropped. The SF fabric ignores both |
| | | frame sequences. It is allowed to drop |
| | | the EOF fragment. The MAC needs the |
| | | frame size in bytes. It can obtained as |
| | | follows: Frame size in byte = {total |
| | | fragment count − 1, payload size of the |
| | | EOF fragment, LSB of byte count of the |
| | | EOF fragment}. Therefore, the frame |
| | | size in bytes is not known until the EOF |
| | | fragment is received. |
| Hash Key | 4 bits | To support the function of port trunking. |
| Dest Device Bit | 16 bits | SF uses this bitmap to forward the |
| map | | multiple copies to its egress ports. |
| Total Frame Count | 4 bits | Total number of messages (fragments). |

Bits 6, 7, and 8 indicate the seven types of messages, and are shown in the following Table 4. Note that Type is defined in the bits[8:6] of the first long word.

TABLE 4
Message Types.

| | Header | | |
|---|---|---|---|
| Name | size | Type | Function |
| Scheduling | 4 | 000 | A control message without any |
| Request | Words | | payload; source DS informs the |
| Message | | | destination DS that one frame is |
| | | | going to be forwarded in response |
| | | | to sending a scheduling request |
| | | | message. |
| Data Request | 4 | 001, | A control message without any |
| Message | Words | with a | payload; when the destination DS |
| | | subtype | is ready to transmit the data |
| | | of | frame, it informs the Source DS to |
| | | 000000 | forward the data frame by sending |
| | | | the Data Request. |
| Data Reject | 4 | 001, | A control message without any |
| Message | Words | with a | payload; when the destination DS |
| | | subtype | is not ready to transmit the data |
| | | of | frame, it informs the Source DS, |
| | | 100000 | which releases the FCB after |
| | | | receiving the Request. |
| Unicast Data | 4 | 110 | Four-word header with a payload; |
| Transfer for SOF | words | | indicates this message is carrying |
| Message | | | the first fragment of a unicast |
| | | | frame. |
| Unicast Data | 2 | 010 | Two-word header with a payload; |
| Transfer for | Words | | indicates this message is carrying |
| Continuous | | | the following fragments of a |
| Frame Message | | | unicast frame. |
| Multicast Data | 4 | 111 | Four-word header with a payload; |
| Transfer for SOF | Words | | indicates this message is carrying |
| Message | | | the first fragment of a multicast |
| | | | frame. |
| Multicast Frame | 2 | 011 | Two-word header with a payload; |
| Data Transfer | words | | indicates this message is carrying |
| for Continuous | | | the following fragments of a |
| Fragment - | | | multicast frame. |
| Message | | | |

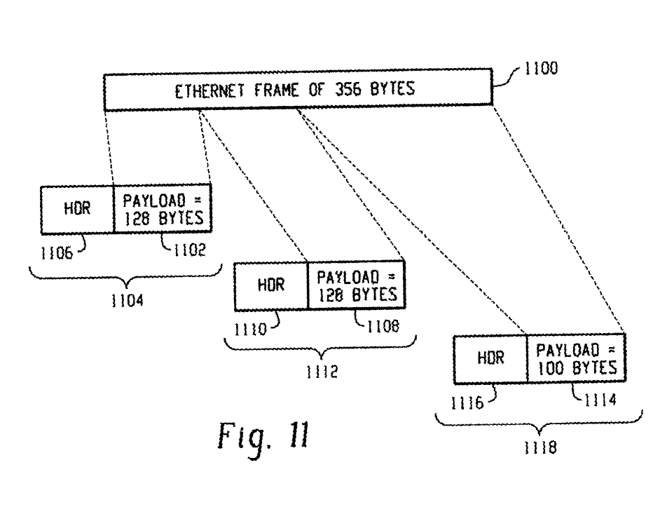

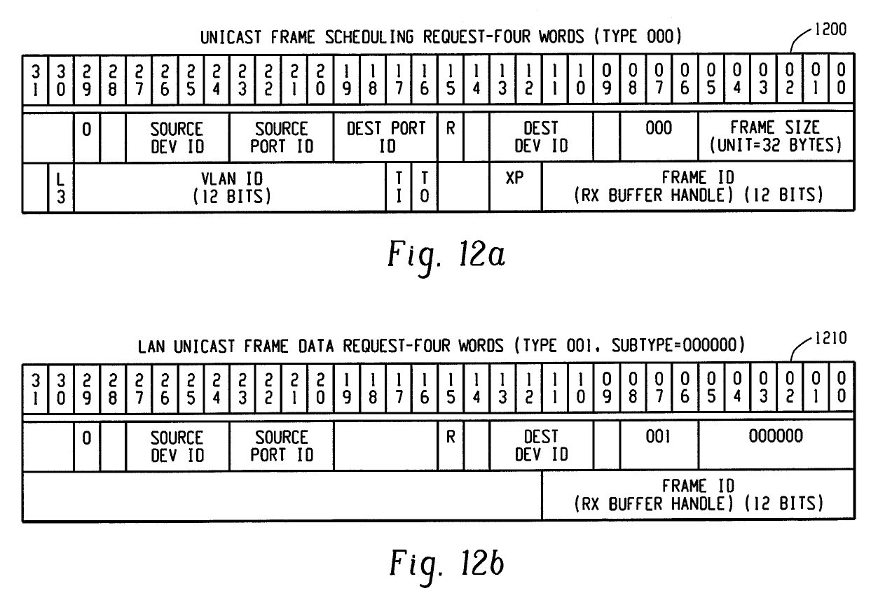

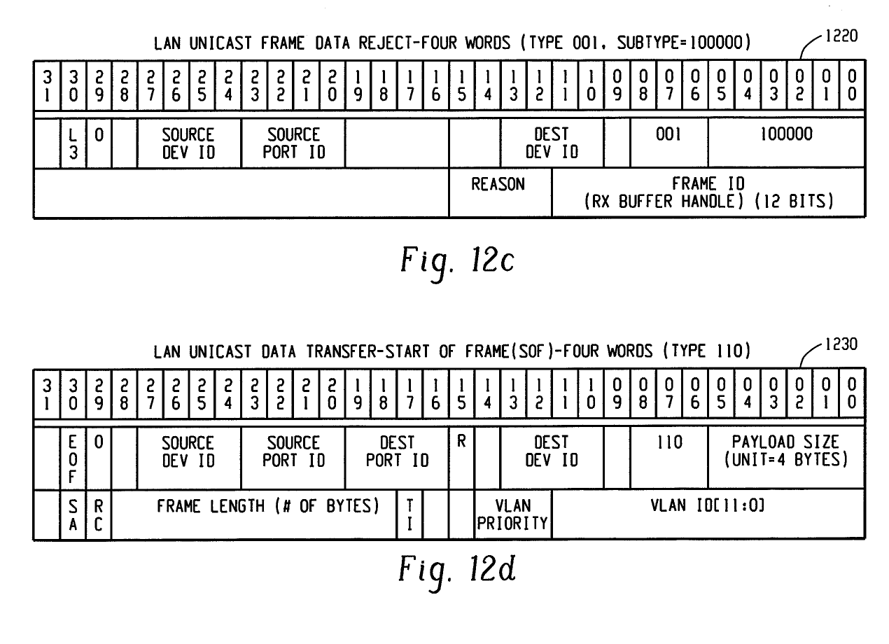

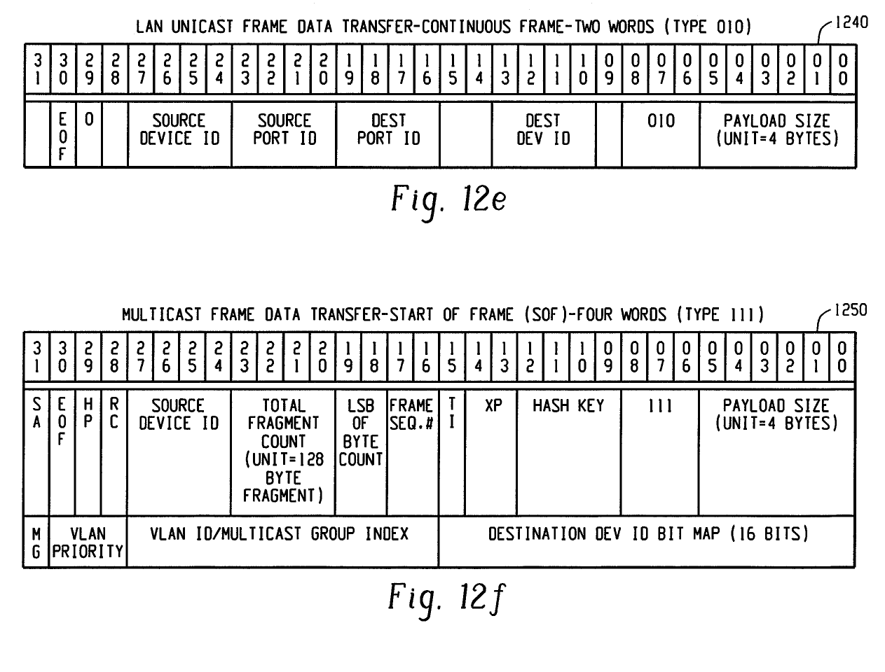

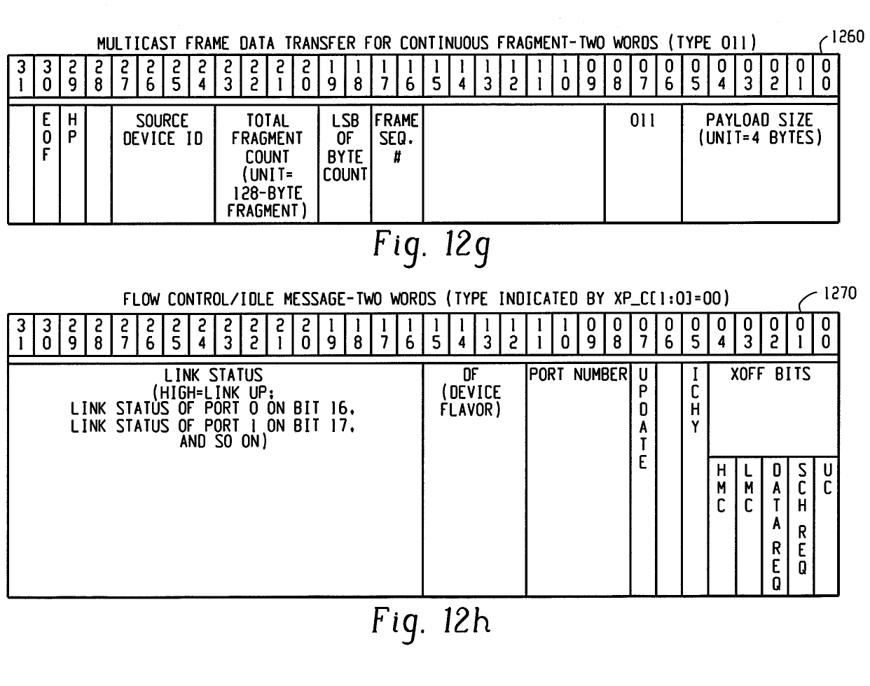

Referring now to FIGS. 12a-12h, there are illustrated various header formats in accordance with the disclosed data path protocol. In FIG. 12a, a unicast (UC) frame scheduling request word 1200 is provided. The scheduling request frame 1200 is four words in length (i.e. 32 bits) and is designated a type 000. When the source device receives an Ethernet frame, a search is performed utilizing the look-up table. In a Layer 2 implementation, the look-up table contains MAC addresses, and in a Layer 3 implementation, a routing table is utilized. In either case, the look-up table is a mapping of a network address to both the destination device ID and its corresponding outgoing port ID. The source device sends this message 1200 to the remote destination device to indicate that it is ready so transmit a new incoming frame. When the destination receives the scheduling request message 1200, it pushes the schedule request 1200 into its corresponding queues based upon the Destination Port ID (outgoing port) and Transmission Priority (XP). The Frame Size bits indicate the length of the frame, which is used for transmission scheduling purpose to provide a quality of service (QoS) function. The FRAME ID is a token to link the requesting frame, which token is passed between the source and destination devices. The VLAN ID field is used to determine the destination port's VLAN membership and tagging status for L2 packets. The L3 bit indicates that the requesting frame is a Layer 3 packet. If the L3 bit is set, or if the source port is 0xF (for the central processing unit or “CPU”), then the “TO” (Tag Out) bit is valid and the VLAN ID field is invalid/ignored. The TI bit is set when the packet was received with a VLAN tag (which tag may need to be stripped by the transmitting media access controller (MAC)). The R (or Rate) bit is set for gigabit frame transfers.

Referring now to FIG. 12b, there is illustrated a unicast frame data request word 1210 format. The data request frame 1210 comprises four words and is designated a type 001 with a subtype=000000. There are two subtypes of unicast frame data requests; a unicast frame data request 1210, and a reject unicast frame data request 1220. For a unicast frame, the destination device sends the unicast frame request data message 1210, having the structure of FIG. 12b, to inform the source device to forward the data frame. The R bit is set for gigabit frame transfers. Note that the Destination Port ID field in data request message 1210 is not used in this embodiment. However, it is available for use in other applications. Note also that the RX Buffer Handle of source node is used as its Frame ID. However, this is an optional implementation.

Referring now to FIG. 12c, there is illustrated the structure of the reject unicast frame data request word 1220. The data reject frame 1220 comprises four words and is designated a type 001 with a subtype=100000. When the destination port is not in a forwarding state, or not a member of the VLAN for L2 packets, the reject message 1220 is sent from the destination device to the source devices in response to the Frame Scheduling Request 1200. The source device releases the corresponding file control block (FCB) after receiving the reject message 1220. The “Reason” field occupies a 4-bit code, and is used to indicate the reason for which the data request was rejected.

Referring now to FIG. 12d, there is illustrated a structure of a unicast start-of-frame (SOF) message 1230. The SOF message 1230 carries the first data fragment in the first message 1104 of the requested long frame 1100. This first data fragment was obtained from the SAR operation which was performed to partition a long frame 1100 (greater than 128 bytes) into smaller fragments. The header (e.g., header 1106) for this first message carries the following information:

Frame Length is the total number of bytes for this frame;

TI is the Tag In bit;

VLAN information which comprises the VLAN ID and the VLAN Priority;

SA is the source address for the transmit port to substitute the source MAC address to the port MAC address (e.g., for an L3 frame);

RC indicates the transmit port to recalculate and replace the CRC for transmission (e.g. for an L3 frame);

EOF indicates that the current message contains a trailer, and that this is the last data fragment of the frame; and

Bit [29]=HP indicates High Drop Priority (this bit is only applied to multicast frames, and Unicast frames are always set to zero).

Referring now to FIG. 12e, there is illustrated header structure for a unicast LAN data transfer continuation frame 1240. This type of message 1240 carries the continuation data fragments of the requested long frame 1100, since the information of frame 1100 has been shown in the first fragment message 1104. Therefore, the header (e.g., header 1110 of the second message 1112) only carries the basic information in the first long word. Note that each egress port requests one data frame at a time. The fragments will be reassembled at the output FIFO queue.

Referring now to FIG. 12f, there is illustrated a header structure for a multicast data start-of-frame transfer word 1250. For multicast frames, the aforementioned 3-way handshaking scheme is not performed. Instead, the source end starts to forward the multicast data frame after it resolves the destination devices. Thus, the header is required to carry more information about the carried data frame. It contains the following:

MG: this bit is set if the multicast group index is valid (interpreting Bit[27:16] of 2^{nd} long Word as VLAN ID or Multicast Group Index). Note that the multicast group index is used for an IP multicast group;

VLAN Information comprises the VLAN priority+VLAN ID;

Destination Device ID bitmap;

SA, EOF, HP, RC bits (as mentioned hereinabove);

Total fragment Count;

Hash Key, which is used for port trunking (to index into the Port Masking table); and

Frame sequence number: fragments of the same frame carry identical frame sequence numbers. The DS discovers the frame boundary by determining the difference in frame sequence numbers, when the EOF fragment of a frame is dropped. The SF ignores both frame sequences numbers. The SF is allowed to drop the EOF fragment.

The MAC needs the frame size, in bytes. The frame size can obtained as follows: Frame size (in bytes)=(total fragment count−1, payload size of the EOF fragment, LSB of byte count of the EOF fragment). Therefore, the frame size in bytes is not known until the EOF fragment is received.

Referring now to FIG. 12g, there is illustrated a header structure for a multicast frame data-transfer-for-continuous-fragments word 1260. The HP (High Priority) bit is cleared for “Discard Eligible” frames (i.e., non-IP Multicast frames). All other frame control information is latched inside the destination frame engine.

Referring now to FIG. 12h, there is illustrated a structure of the flow control/idle message 1270. All messages, except flow control messages 1270, are subject to flow control. The flow control message 1270 will never get into the FIFO, so it can not cause FIFO overruns, and cannot be stopped by an XOFF signal.

In the daisy chain mode, flow control is out-of-band. There are two signals that provide flow control information: XOFF_FCM and XOFF_FCU. The UC flow control signal (XOFF_FCU) affects all non-multicast (non-MC) traffic. If any non-MC traffic FIFO is full, it will trigger UC flow control to the upstream device, which will stop the transmission of all non-MC traffic, bypass or locally generated. The MC flow control signal (XOFF_FCM) stops transmission of all MC traffic (bypass or locally generated).

In-band flow control by the Flow Control/Idle Message has application in matrix mode. The DF (Device Flavor) bits are used to indicate either the SF is in 4×4 mode (bits 0000) or 8×4 mode (bits 0001). Other bit combinations are reserved for future use. It carries no meaning when a DS sends it. (This DF field can be used to specify the feature of the connected device.) The ICHY (“I Cannot Hear You”) bit, if set, means the sender of this idle message 1270 cannot receive from this link. Link partners exchange cleared ICHY bits to confirm that the link is full duplex; otherwise the link partners will declare the link down. The Update bit is used to request the link partner to update its flow control status by sending a new idle message 1270, and is usually used after the reception of a parity-erred message. The port number of the Link Status and Port Number bits refers to the port from which this idle message 1270 is sent so that the downstream device knows to which port of the SF it is attached. For a SF, if the nth incoming message of a particular port is healthy, the nth bit of the link status will be set. Thus, the 16-bit link status will give the up/down link information of the sixteen ports of the SF. The bit referring to the sending port is ignored. To be consistent, the DS considers its only port as port 0. The 0^{th} bit of the link status will tell the status of its only incoming message port, and all the other bits of the link status are cleared to 0. In daisy-chain mode, the port number is the bootstrapped device number of the DS. All other fields are not used.

When the DS is the sender of flow control in SF mode, and a DS FIFO is getting full, it needs to send a flow control message to stop the SF from sending more traffic to prevent overrun of its FIFO. The DS does not have per-destination receive FIFOs. When the SCH REQ receive FIFO is reaching capacity, it turns on the XOFF SCH REQ bit in the flow control message 1270. When the DATA REQ receive FIFO is reaching its capacity, it turns on the XOFF DATA REQ bit in the flow control message 1270. Theoretically, the DS should not send UC flow control since UC messages have a delay-free path to the MAC TX FIFOs.

When the low priority MC FIFO is reaching its capacity, it triggers the low priority MC flow control bit. When the high priority MC FIFO is reaching its capacity, it triggers the high priority MC flow control bit.

When the SF is the sender of flow control, an input port to the SF feeds seven UC FIFOs and two MC input FIFOs. When any one of the UC message FIFOs reaches capacity, three flow-control bits are set: the UC bit, SCH REQ and the DATA REQ XOFF bits. This signals the upstream DS to stop transmission of the three types of messages that require storage in the UC FIFOs. The MC XOFF bit reflects the FIFO occupancy of the MDN input FIFO: one bit for high priority MC, and one bit for low priority MC.

With respect to the DS response to flow control, the five bits of flow control correspond to the five transmit (TX) FIFOs. Note that the CPU message receive FIFO will never overflow. Once the occupancy of the CPU message receive FIFO exceeds a programmable threshold, a state machine, which is responsible to move CPU messages to the memory, will read and discard the HOL message.

With respect to the SF's response to flow control, each SF has seven FIFOs feeding one output port for SCH REQ, DATA REQ and UC messages. The output module round-robins among theses seven FIFOs. When either SCH REQ, DATA REQ or UC XOFF are triggered, the FIFOs that have this particular type of message will be taken out of the contention to transmit. Where UC XOFF, FIFOs that have a UC message at HOL, are taken out of contention. For DATA REQ XOFF, FIFOs that have a DATA REQ message at HOL, are taken out of contention. Where SCH REQ XOFF, FIFOs that have a SCH REQ XOFF message at HOL, are taken out of contention. For an MC XOFF, each MC bit stops the transmission of the MC messages which are stored in the MC output FIFO. A low MC XOFF stops Lo MC transmission from the low priority MC output FIFO. A Hi MC XOFF stops Hi MC transmission from the high priority MC output FIFO.

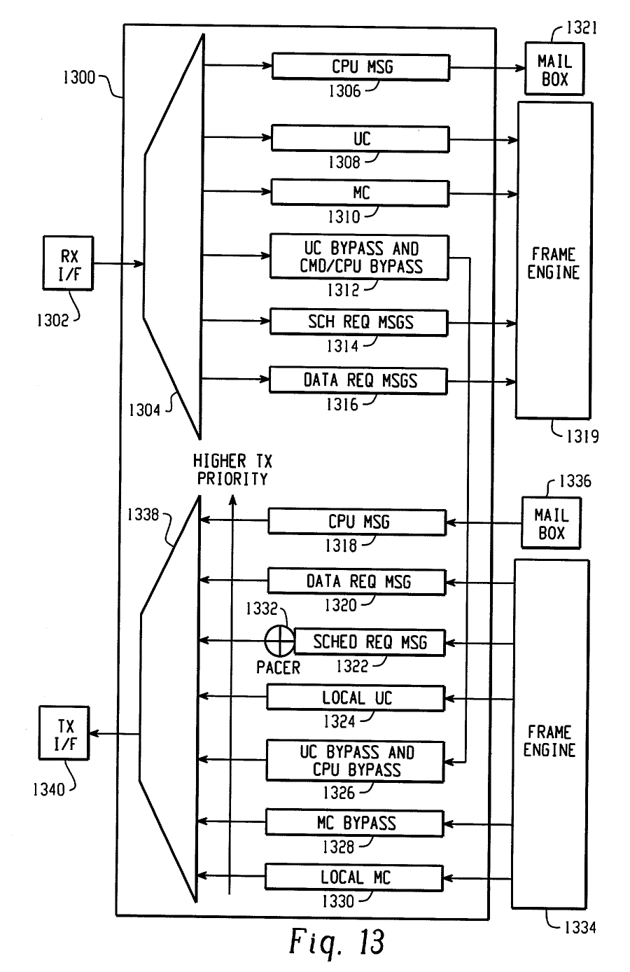

Referring now to FIG. 13, there is illustrated a transmit/receive FIFO structure 1300 utilized for the daisy-chain mode of operation, according to a disclosed embodiment. The FIFO 1300 receives messages via a receive interface port 1320. Various parts of the message are then extracted utilizing a receive router 1304 and sent to the following respective transmit queues (including, but not limited to); CPU message queue 1306, a unicast data queue 1308, MC data queue 1310, a UC bypass and CMD/CPU bypass queue 1312, a schedule request queue 1314, and a frame data request queue 1316. The outputs of these queues are then passed to a frame engine 1319, except the contents of the CPU message queue 1306, which is passed to a mailbox 1321. A configuration message can also be placed into the CPU message queue 1306.

On the transmit side of the FIFO 1300, the CPU sends the contents of an associated transmit mailbox 1336 to a transmit CPU queue 1318, and a frame engine 1334 (which may be the same frame engine 1319 of the receive logic of the FIFO 1300) sends information to various other queues (including, but not limited to): a frame data request queue 1320, a frame scheduling request queue 1322, a local unicast queue 1324, a UC bypass and CMD/CPU bypass queue 1326, an MC bypass queue 1328, and a local MC queue 1330. Frame request pacing is performed with a pacing logic 1332 between the frame data request queue 1320, frame scheduling request queue 1322, and local unicast queue 1324. Data is pulled from the transmit queues to assemble a word utilizing a transmit router 1338, which is then transmitted out a transmission interface 1340 to the next device on the network. Transmit priority is implemented in increasing priority from the local MC queue 1330 to the CPU message queue 1318. However, note that the daisy-chain mode disallows high or low priority MC. The UC bypass queue 1312 is operable to pass data directly to the transmit side UC and CMD/CPU queue 1326 of the FIFO 1300, when performing a bypass operation.

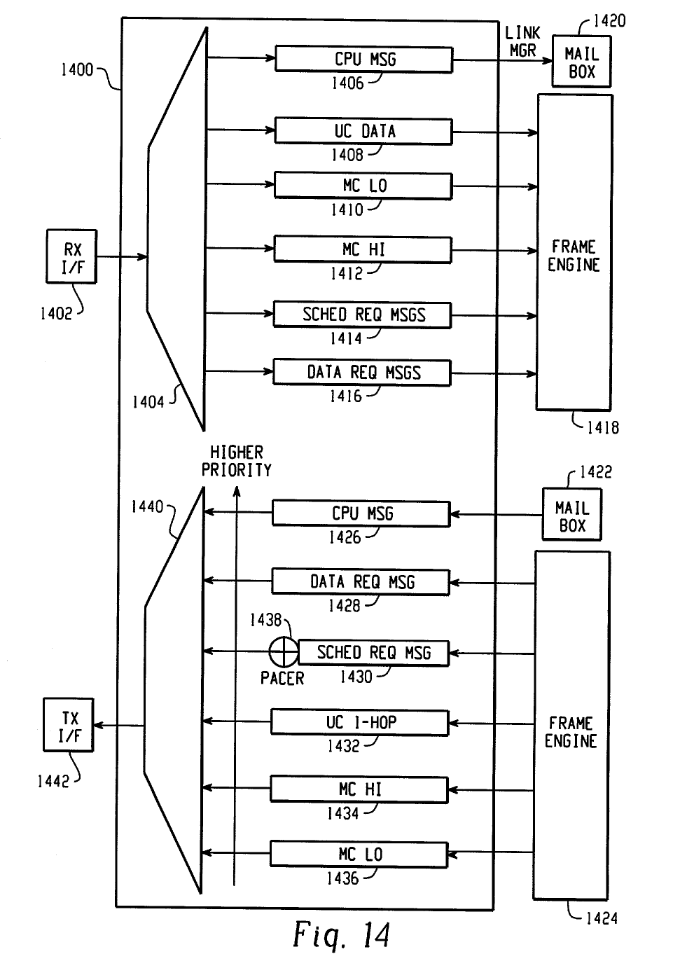

Referring now tho FIG. 14, there is illustrated a transmit/receive FIFO structure 1400 utilized for the matrix mode of operation, according to a disclosed embodiment. The FIFO 1400 is used for a different type of data traffic. The FIFO 1400 receives messages via a receive interface port 1402. Various parts of the message are then extracted utilizing a receive router 1404 and sent to the following respective transmit queues (including, but not limited to); CPU message queue 1406, a unicast data queue 1408, MC low queue 1410, MC high queue 1412, a schedule request queue 1414, and a frame data request queue 1416. The outputs of these queues are then passed to the frame engine 1418, except the contents of the CPU message queue 1406, which is passed to a receive mailbox 1420.

On the transmit side of the FIFO 1400, the CPU, which functions to retrieve the contents of the receive-side mailbox 1420, also sends information from a transmit mailbox 1422 to a CPU message queue 1426, and a corresponding frame engine 1424 (it may be the same frame engine 1418) sends information to various other queues (including, but not limited to): a frame data request queue 1428, a frame scheduling request queue 1430, a unicast 1-hop queue 1432, an MC high queue 1434, and an MC low queue 1436.

Frame request pacing is performed with a pacing logic 1438 between the frame data request queue 1428, frame scheduling request queue 1430, and unicast 1-hop queue 1432. Data is pulled from the transmit queues to assemble a word, utilizing a transmit router 1440, which word is then transmitted out a transmit interface 1442 to the next device on the network. Transmit priority is implemented in increasing priority from the MC queue 1436 to the CPU message queue 1426.

Although the preferred embodiment has been described in detail, it should be understood that various changes, substitutions and alterations can be made therein without departing from the spirit and scope of the invention as defined by the appended claims.

What is claimed is:

1. A method of communicating a data frame of a source device of a network, comprising the steps of:
resolving the data frame at the source device to ascertain the data frame type; and
forwarding the data frame with a virtual network identifier and priority information from the source device to a destination device of the network.

2. The method of claim 1, wherein the data frame forwarded in the step of forwarding further includes control information.

3. The method of claim 1, wherein the source and destination devices are both distributed switches.

4. The method of claim 3, further comprising the step of providing a handshake protocol for transmitting the data frame, the protocol step comprising,
transmitting a source control message from the source device to the destination device in response to the step of resolving;
transmitting a destination control message from the destination device to the source device; and
forwarding the data frame from the source device to the destination device in response to the source device receiving the destination control message.

5. The method of claim 4, wherein the step of providing occurs in response to the data frame being a unicast frame.

6. The method of claim 4, further comprising the steps of:
enqueueing the source control message in a transmit queue of the destination device; and
determining when the source control message is at a head-of-line position in the transmit queue and the destination device is ready to transmit the data frame.

7. The method of claim 6, wherein the step of transmitting the destination control message occurs in response to the step of determining.

8. The method of claim 4, wherein if the data frame exceeds a predetermined size, the data frame is processed into a plurality of smaller frame segments such that the step of forwarding occurs repeatedly until the plurality of smaller frame segments have been forwarded to the destination device.

9. The method of claim 8, wherein a first smaller frame segment of the plurality of smaller frame segments is associated with a start frame, which start frame is forwarded to the destination device in the step of forwarding.

10. The method of claim 8, wherein one or more smaller frame segments of the plurality of smaller frame segments are associated with a continuation frame, which continuation frame is forwarded to the destination device in the step of forwarding.

11. The method of claim 8, wherein the plurality of frame segments received at the destination device are reassembled into the data frame.

12. The method of claim 4, wherein the source control message in the step of transmitting is a scheduling request message, and the destination control message in the step of transmitting is a data request message.

13. The method of claim 4, further comprising the step of generating a look-up table, which look-up table contains a mapping of a network address to a device identifier and an outgoing port identifier, such that when the data frame is resolved in the step of resolving, the look-up table is accessed to determine the device identifier and outgoing port to which the data frame is transmitted.

14. The method of claim 13, wherein the look-up table in the step of generating is a source look-up table generated in the source device.

15. The method of claim 13, wherein the address is a MAC address of the destination device.

16. The method of claim 4, wherein the data frame in the step of resolving is a unicast Ethernet frame.

17. The method of claim 4, wherein the destination control message in the step of transmitting is a data request message including a frame identifier that is a receive buffer handle.

18. The method of claim 4, wherein the destination control message in the step of transmitting is a data request message including subtype indicator.

19. The method of claim 4, wherein the destination control message in the step of transmitting is a data reject message including a frame identifier that is a receive buffer handle.

20. The method of claim 4, wherein the destination control message in the step of transmitting is a data reject message including subtype indicator.

21. The method of claim 3, wherein the data frame is a multicast frame that is routed according to one of bitmap information and a multicast identifier field.

22. The method of claim 21, wherein if the data frame exceeds a predetermined size, the data frame is processed into a plurality of smaller frame segments such that the step of forwarding occurs repeatedly until the plurality of smaller frame segments have been forwarded to the destination device.

23. The method of claim 22, wherein a first smaller frame segment of the plurality of smaller frame segments is associated with a start frame, which start frame is forwarded to the destination device in the step of forwarding.

24. The method of claim 22, wherein one or more smaller frame segments of the plurality of smaller frame segments are associated with a continuation frame, which continuation frame is forwarded to the destination device in the step of forwarding.

25. The method of claim 22, wherein the plurality of frame segments received at the destination device are reassembled into the data frame.

26. The method of claim 1, wherein the source device is a distributed switch and the destination device is a switch fabric.

27. The method of claim 26, further comprising the step of providing a handshake protocol for transmitting the data frame, the protocol step comprising,
transmitting a source control message from the source device to the destination device in response to the step of resolving;
transmitting a destination control message from the destination device to the source device; and
forwarding the data frame from the source device to the destination device in response to the source device receiving the destination control message.

28. The method of claim 27, wherein the step of providing occurs in response to the data frame being a unicast frame.

29. The method of claim 26, further comprising the steps of:
enqueueing the source control message in a transmit queue of the destination device; and
determining when the source control message is at a head-of-line position in the transmit queue and the destination device is ready to transmit the data frame.

30. The method of claim 29, wherein the step of transmitting the destination control message occurs in response to the step of determining.

31. The method of claim 26, wherein if the data frame exceeds a predetermined size, the data frame is processed into a plurality of smaller frame segments such that the step of forwarding occurs repeatedly until the plurality of smaller frame segments have been forwarded to the destination device.

32. The method of claim 31, wherein a first smaller frame segment of the plurality of smaller frame segments is associated with a start frame, which start frame is forwarded to the destination device in the step of forwarding.

33. The method of claim 31, wherein one or more smaller frame segments of the plurality of smaller frame segments are associated with a continuation frame, which continuation frame is forwarded to the destination device in the step of forwarding.

34. The method of claim 31, wherein the plurality of frame segments received at the destination device are reassembled into the data frame.

35. The method of claim 26, wherein the source control message in the step of transmitting is a scheduling request message, and the destination control message in the step of transmitting is a data request message.

36. The method of claim 26, further comprising the step of generating a look-up table, which look-up table contains a mapping of a network address to a device identifier and an outgoing port identifier of an outgoing port, such that when the data frame is resolved in the step of resolving, the look-up table is accessed to determine the outgoing port to which the data frame is transmitted.

37. The method of claim 36, wherein the look-up table in the step of generating is a source look-up table generated in the source device.

38. The method of claim 36, wherein the address is a MAC address of the destination device.

39. The method of claim 26, wherein the data frame in the step of resolving is a unicast Ethernet frame.

40. The method of claim 26, wherein the destination control message in the step of transmitting is a data request message including a frame identifier that is a receive buffer handle.

41. The method of claim 26, wherein the destination control message in the step of transmitting is a data request message including subtype indicator.

42. The method of claim 26, wherein the destination control message in the step of transmitting is a data reject message including a frame identifier that is a receive buffer handle.

43. The method of claim 26, wherein the destination control message in the step of transmitting is a data reject message including subtype indicator.

44. The method of claim 25, wherein the data frame is a multicast frame that is routed according to one of bitmap information and a multicast identifier field.

45. The method of claim 44, wherein if the data frame exceeds a predetermined size, the data frame is processed into a plurality of smaller frame segments such that the step of forwarding occurs repeatedly until the plurality of smaller frame segments have been forwarded to the destination device.

46. The method of claim 45, wherein a first smaller frame segment of the plurality of smaller frame segments is associated with a start frame, which start frame is forwarded to the destination device in the step of forwarding.

47. The method of claim 45, wherein one or more smaller frame segments of the plurality of smaller frame segments are associated with a continuation frame, which continuation frame is forwarded to the destination device in the step of forwarding.

48. The method of claim 45, wherein the plurality of frame segments received at the destination device are reassembled into the data frame.

49. A network architecture for communication between a plurality of network devices, each network device of the plurality of network devices comprising:
a receive buffer for receiving incoming data from an upstream network device of the plurality of network devices;
a transmit buffer for transmitting outgoing data to a downstream network device of the plurality of network devices;
receive control logic operating in conjunction with said receive buffer for controlling said incoming data from said upstream network device; and
transmit control logic operating in conjunction with said transmit buffer for controlling said outgoing data to said downstream network device;
wherein in a first mode, flow of said incoming data and said outgoing data between the plurality of network devices is in one direction;
wherein in a second mode, flow of said incoming data and said outgoing data is bidirectional between the plurality of network devices.
